(19) United States
(12) Patent Application Publication
(10) Pub. No.: US 2009/0119942 A1
(43) Pub. Date: May 14, 2009

(54) Hand dryer

(75) Inventors: Sol Aisenberg, Natick, MA (US); George Freedman, Wayland, MA (US); Richard Pavelle, Winchester, MA (US); Aharon Zeev Hed, Nashua, NH (US)

Correspondence Address: K.F. ROSS P.C., 5683 RIVERDALE AVENUE, SUITE 203 BOX 900, BRONX, NY, 10471-0900, US

(73) Assignee: Invent Resources, Inc.

(21) Appl. No.: 11/985,240

(22) Filed: Nov. 14, 2007

(51) Int. Cl. F26B 21/00; F26B 7/00

(52) U.S. Cl. 34/418; 34/523

(57) ABSTRACT

A dryer uses a high-speed blower producing high velocity air, a heater and a compound directional nozzle containing multiple tubular, cylindrical air sub-outlets to generate both suitable force and temperature in the sub-jets of air to dry the user's hands. The air outlets are sized and shaped to maintain direction of airflow at the location of the hands. The multiple tubular sub-nozzles reduce the air turbulence noise from the fast airflow sub-jets striking the hands by providing spaces between the adjacent sub-nozzles and air sub-jets so that the turbulence and hand impact noise is reduced and so that the water evaporated from the water film has a shorter escape distance. An ion source provides ions in the output air from the compound directional nozzle to enhance evaporation.

### BACKGROUND OF THE INVENTION

1. Field of the Invention

The present invention relates to lowering air impact noise of the air used in drying hands and the like with a blower-type dryer, and is achieved by using a compound directional nozzle containing an array of sub-nozzles.

2. Description of the Related Art

Conventional hand dryers dry an individual's wet hands in one of two ways, evaporative drying or “blow-off” drying. (In the blow-off case, a small amount of evaporation occurs, but it is incidental and minimal since the air stream usually is not yet warmed at the start because of the thermal time lag.)

Conventional evaporative hand dryers include a blower for generating an air stream through a ducting system to one or more air exit outlets that directs the air stream onto the hands of the user. An internal heating device may be included to heat the air stream. The hand dryers generally include a push button, photocell sensor or other means to actuate the blower and heater for a predetermined time period (e.g. 30 seconds).

Evaporative drying changes the physical state of the water to be dried away from liquid to vapor and thus requires more energy and more time than blow-off drying which merely moves the water off the hands. Blow-off drying alone always leaves a small amount of moisture on the hands that result in discomfort due to evaporative cooling of the hands. Thus there is a need for our hybrid system combining the best features of both procedures. It involves fast forceful streams of air that blow off loose water and then aids evaporation of the remaining film of water by breaking up the stagnation layer of air adjacent to the water film. At the end of the hybrid cycle there is so little residual moisture on the hands that there is no evaporative cooling and hands are warm and more comfortable than in with evaporation alone or blow-off alone. Our hybrid system will achieve complete and comfortable drying in one third the time required for evaporative drying—10 to 15 seconds vs. 30 to 45 seconds or even a second cycle of the same duration. Evaporative drying requires this additional time because the air stream is diffuse and dissipates much of its energy in heating surrounding air rather than the hands.

The longer time that the hand dryers need to operate and dry, the more electrical power is used, and this can be a serious problem because of the cost, increasing cost, and limited availability of energy. With faster drying the energy used for air conditioning of the public bathrooms, is also reduced because of the reduced heat produced by shorter drying times. Also, user satisfaction increases with faster drying. In fact, sometimes users of conventional dryers find they must repeat the drying cycle in order to dry the hands more completely, which increases the energy usage.

In addition, because of the longer drying time otherwise needed, users are sometimes reluctant to wash their hands when using public washrooms, and this can encourage the transmission of infections. This can be potentially serious if problems such as bird flu mutate to the point where they become infectious and transmissible among humans.

Attempts to improve energy efficiency in the prior art include providing an enclosure for the hands, re-circulating air and pre-drying the air. This enclosure is awkward for the user, with the risk of contacting the nearby enclosure walls and infectious material.

There is therefore a need for a safer, more convenient, more energy efficient dryer having a shorter drying cycle than the current state of the art to conserve energy and to encourage the washing and drying of hands to improve healthy conditions.

Dryer nozzles present a problem in that users are often tempted to stuff napkins or towels into them, hoping to cause a pressure driven “explosion”. There is a need to thwart insertion of foreign materials by users. By virtue of the use of a compound directional nozzle containing smaller internal sub-nozzles, described below, our dryer version will prevent such actions by users.

The longer drying time of other hand dryers can result in longer discouraging waiting time in public bathrooms where there are many people waiting their turn to use the slower dryer. This can reduce the number of people who would otherwise wash their hands, thus resulting in reduced hygiene and safety. Our dryer will reduce drying and waiting time and thus can add to health safety.

In all blower-type hand drying systems as well as in our hybrid system, in addition to the advantage of faster more comfortable drying, there are benefits of reduced energy. Also with the reduced use of paper towels there are the benefits of saving trees normally used to make paper towels, and the reduced need for more land fills to contain the paper towels. Also there is reduced need for attendants to periodically refill the towel dispensers.

The drying time for conventional evaporative hand dryers is relatively long, taking 30 to 45 seconds or more to dry a user's hands. Conventional dryers suffer from low energy efficiency. The low energy efficiency is a result of the following operating factors: longer operating time required for drying; heating up the internal dryer components; not maximizing and optimizing air flow temperature, direction and velocity; not compensating locally for evaporative cooling; and also not addressing the problem of a stagnation boundary layer of air and water molecules adjacent to the water film on the hand, which inhibits net evaporation of water from the skin surface of the hands. Attempts to improve energy efficiency in the prior art include providing an enclosure for the hands, re circulating air and pre-drying the air. There is therefore a need for a more energy efficient dryer having a shorter drying cycle than the current state of the art. The compound directional nozzle and longer sub-nozzles of our invention will satisfy this need.

A major impediment to rapid evaporation from water on the hands is the presence of a stagnation boundary layer, which is a region of slower flowing air adjacent to the surface of the hands. The stagnation boundary layer corresponds to the transition region adjacent to the hands where air and water evaporating from the hands is moving much slower than the fast region of air flow, because of drag on the stagnation air flow by the stationary surfaces of the hands.

In this stagnation boundary layer, the water molecules evaporating from the water films on the hands will accumulate, and about as many will flow back to the water surface as will flow away into the faster flowing stream of air thus reducing the net evaporation. This stagnation boundary layer inhibits the net evaporation of surface water. The fast turbulent airflow provided by the present invention clears the stagnation boundary layer and the evaporating moisture it contains. Our hybrid system is unique in the field in that it disrupts the stagnation boundary layer as part of the drying, and provided regions of reduced air flow and turbulence within the array of flowing air to help in the escape of water from the hand surface water films.

By breaking up and reducing the stagnation boundary layer with a strong airflow including a component of airflow perpendicular to the surface, the evaporation rate is increased. Rather than accumulating in the stagnation boundary layer and inhibiting the net evaporation of water, the water molecules in the stagnation boundary layer are swept away, as fast as they accumulate, by the air breaking up and reducing the stagnation boundary layer. U.S. Pat. No. 6,038,786, to Aisenberg et al., the entire contents of which are incorporated herein by reference, discloses a hand dryer that improves dispersion of the boundary layer. The quantity of air impacting on the hands can be controlled by adding to the air entrained in the main jet or jets of air. This is described in U.S. Pat. No. 7,039,301 to Aisenberg et al., the entire contents of which are incorporated herein by reference. However sometimes the noise caused by the air impacting the hands during drying can be unacceptable. Therefore there is a need for a dryer that produces less air impact noise on the hands while still drying quickly and comfortably.

An existing hand dryer is the XLerator™ dryer made and distributed by Excel dryer, Inc. embodies many of the features described in the U.S. patents of Aisenberg et al. cited above and which are assigned to Excel Dryer Inc.

To diffuse the stagnation boundary layer, a second type of conventional hand dryers, such as is described in U.S. Pat. No. 5,459,944 to Tatsutani et al., uses “blow off” or “air knife” technology instead of evaporation (although a small amount of evaporation occurs). These blow-off dyers provide an intensive blast of high velocity air which, when suitably deployed, blows or skives droplets of water off the user's hands. However the separation between the distance between the “air knife” air exits and the hands being dried is small and the hands cannot be rotated or rubbed in order to improve the drying, particularly between the fingers. Because of the small spacing in the enclosure in which the hands are placed, there is the danger of the hands contacting the enclosure walls and thus possibly picking up infectious material left from previous users.

It has been found that after using a conventional “blow-off” hand dryer, the hands feel cold and slightly moist, as a result of the heat loss and subsequent cooling due to evaporation of some of the residual moisture that has not been blown off. The hands are cooled during blow off drying because even room air that has not been heated will evaporate some water, and the remaining water and surface and hands will thus be cooled by the heat loss due to evaporation. This discomfort is present during the early drying and for about 30 seconds after drying until the hands return to normal temperature, after the end of the cooling effect of the evaporation of the remaining water film. Using conventional air-drying the hands feel cool and clammy, and it is observed that frequently users will wipe their hands on their clothing after conventional drying and this is not very sanitary. There is therefore a need for a hand dryer providing for rapid drying and post drying comfort to the user.

It is desirable for the hand dryer to completely dry the hands to a comfortable and warm state in a short time to encourage washing of hands for sanitary reasons. Reducing the drying time also reduces energy consumption.

When blow-off is used, impact of the air stream on the wet hands results in an elevated noise level. Some users find this objectionable. Accordingly, there is a need for a dryer with means to lower this noise level without compromising the good drying effect of high impact blow-off. Our dryer invention achieves this.

### DEFINITIONS AND DESCRIPTIONS

For the purpose of this invention, the following definitions and descriptions are used:

A “compound directional nozzle” is defined here as the part of the dryer that permits the fast air to exit with a directional component. It consists of an array of smaller long cylindrical nozzles (sub-nozzles) deployed within a sheath of metal or plastic or without the sheath. Accordingly an external view of the compound directional nozzle shows it to appear to be a simple cylinder or other simple shape, and Sub-nozzles may be included out of sight, internally.

“Sub-nozzles” are defined here as the smaller cylindrical nozzles internally built into a compound directional nozzle that has two or more internal long cylindrical “sub-nozzles.” These direct the exiting air at the surfaces to be dried. The sub-nozzles have a length that is at least about 3 to 5 times the largest lateral dimension of the sub-nozzle channel, and they are spaced to provide separation between the impact locations on the surfaces to be dried. This facilitates the reduction of turbulent impact noise by providing a shorter distance for the turbulence to escape to a less turbulent region, and also a shorter distance for the water to escape. The length of the cylindrical sub-nozzles preserves much of the directional flow properties of the exiting air to the location of the hands being dried.

The sub-nozzles can consist of independent cylindrical tubes, or of independent cylindrical holes or channels drilled or formed in a solid portion of the nozzle, or a combination of such cylinders.

“Cylindrical” is defined here as having the shape of a cylinder, especially of a circular cylinder, although it also can have other cross sections such as but not limited to an ellipse, rectangle, or square. The cylinder defined here also can have varying cross sections at different positions in the cylinder longitudinal positions.

“Forceful air flow” is defined here as blown air moving at a velocity fast enough to mechanically blow off loose surface water in a short time such as but not limited to 2 to 5 seconds and to break up the stagnation air layer adjacent to a water film on a relatively slower surface.

“Rapidly” is defined here as less than 20 seconds.

“Comfortably” is defined here as not feeling cool or clammy after being dried and not needing to be further dried with a towel or being wiped in clothing to remove residual water.

“Infectious material” is defined here as consisting of bacteria, viruses, spoors, and/or mold.

“Typical population” is defined here as consisting of people such as men, women, with a range of hand sizes.

“Filter” is defined here as a component that will trap and or block, foreign infectious material and/or small particles and to reduce and/or prevent such material from entering the blower and/or departing from it.

A “blower-type” drying system is defined hers as one deployed within a suitable mounted housing. It includes an electrical blower motor integral with a fan that generates an air stream. Said air stream may be directed by suitable ducts through an electric heater for raising its temperature and then through a nozzle or array of multiple nozzles to produce an air jet or jets which are directed at the object to be dried. Included in blower-type drying systems is that which functions almost exclusively by evaporating the water on the hands. Included in blower-type drying systems is that which functions almost exclusively by blowing off the water on the hands with essentially no evaporation.

A “hybrid-type” drying system is that which combines blowing-off of water and evaporation of water. Thus a hybrid device provides a combination of two modes of drying—blowing off and evaporation of water on the hands.

“OAIA” is an acronym for “Optimum Air Impact Area,” referring to total nozzle area range at which better drying efficiency occurs.

### Enabling Description of Measurement and Testing Methods

An important part of the invention validation process was the creation and use of a measurement technique to quantify the amounts of water on the hands during the development, testing, and demonstration phases, including demonstration of the working and utility of the invention. The residual water was measured using a process that takes into account variations in hand size, hand movements during drying, soaping, and ambient temperature and humidity.

Measurement of the water on the hands initially (before drying) was made after washing the hands and then after shaking the hands 2 times to remove loose water, as is sometimes done by those washing hands. Measurement of the water on the hands was made after interrupted drying times such as but not limited to 2, 5, 7, 10, 15, 20, 25, 30, or 45 seconds.

Measurements of the water on the hands after a measured time of drying were made by wiping the hands with a dry paper towel that was weighed to a resolution of 0.01 grams on an electronic digital scale before being used for wiping and then after wiping. The weight change was used to measure the water weight remaining on the hands as a function of each drying time. Weight measurements for each drying time were repeated at least 4 times to verify the reproducibility, and the average was used.

The average of a number, N, of measurements (in the form of numbers) is defined and computed by summing the individual measurements and then dividing by the number of measurements, N, to result in the average.

Measurements were made using an average population.

An “average population” is defined here as selected from both sexes and having hands running from “small” to “large” and which uses varied individual hand movements during drying including shaking, wiping, rotating, wringing, etc. We found that typical populations for whom residual water values are measured and then averaged give repeatable data. Acceptable hand dryness based upon averaged residual values is found to give acceptable dryness when such averaged values of residual water on the hands are under 0.20 grams as described above.

### SUMMARY OF THE INVENTION

This invention achieves significant reduction in air impact noise by presenting the blow-off air to the hands by using an array of long smaller nozzles (sub-nozzles) situated within a single nozzle shell. The selected areas and separations of these smaller nozzles dissipate impact energy with controlled turbulence that results in less noise than if supplied by a single channel.

Advantageous and unique features included in the present invention are:

(a) Faster drying, (b) Use of blow off of water in addition to evaporation, (c) Comfortable drying in which dried objects such as hands feel warm and dry immediately after the drying process ceases, (d) Reduced energy requirement, (e) Reduced noise from air impact on the hands, (f) Ability to provide a pulsing nature to the exiting air, (g) Use of a compound directional nozzle to give sub-jets of air to reduce turbulence noise and facilitate escape of water, (h) Addition of ions to the air sub-jets or air jet to increase the rate of evaporation of water

Thus the present invention will provide means to provide the features described above, and meet the objectives including faster drying, comfortable drying, reduced air-hand impact noise, and these means can be used individually or in various combinations.

An enabling description of the measuring, testing, and demonstration methods used to demonstrate the working of this invention is included in the teaching.

The evaporation of the water droplets or islands of water on the hands is accelerated by the blowing of added electrical charges in the exiting air to arrive on the surface of the evaporating material. Such charges can be in the form of electrons or ions. The generation and employment of ions is known to aid evaporation in hair drying. Our invention extends this technology to include the use preferably of corona discharge and/or the mineral tourmaline to provide ions in aiding evaporation in hand dryers.

In the present invention the jets of forceful airflow exit through a compound directional nozzle containing multiple cylindrical or similar shape channels, like cannon or rifle barrels, so that the airflow retains its force and direction at remote sites where the hands are located. The channels are long enough to provide directionality to the air flows and are not so long as to significantly reduce the pressure available at the hands.

There is a range of “optimum air impact area” (OAIA) where more effective drying (reduced residual water on hands for an average population) takes place. This effective range occurs when the air stream is most forceful, directional and concentrated (not diffuse) and not too small in area (which would otherwise require additional hand manipulation before scanning the entire hands). The OAIA is evaluated and demonstrated by observing drying performance for each nozzle design.

As an additional advantage of our present invention the internal sub-nozzles of the compound directional nozzle are small and reduce the ability of others to physically block the air exits by insertion of foreign materials.

The significant advantage offered by employing a compound directional nozzle as described above to replace a conventional single channel nozzle of the same dimensions is that they suppress much of the air impact noise when the blow-off air stream collides with the surface of the hands being dried. When such noise suppression is combined with conditions that make for optimum air impact area (OAIA) then swifter and reduced noise drying is achieved.

Another version of our dryer using multiple nozzles uses the tilting of the entire array of nozzles so that the array of air stream jets emerging from these nozzles is tilted at angles such as but not limited to from 10 to 60 degrees from the perpendicular to the to the base of the nozzles. This results in a component of skimming off of water as in air knife technology in addition to just impact blowing off. Skimming requires less energy than normal blow-of and makes the drying process more efficient. This provides a benefit of less noise associated with the same amount of drying

These air outlets are sized and shaped to entrain a sufficient amount of air so as to increase the volume and force of the air stream while not entraining too much air, which would otherwise significantly reduce the air stream temperature and force. Additionally, the air outlets design allows for reduced air impact noise at the hands. The multiple, spaced air outlets control the distribution and energy of the drying air over a larger region of the hands. This improved air outlet provides reduced drying time and in-process comfort and results in improved dryer performance and comfort.

Air driers that have shorter air exit openings do not have strong directional components of the exiting air. However, our dryer uses a longer nozzle that provides directionality to the exiting air. Rather than a nozzle with one large inner diameter air exit channel, our dryer used a compound directional nozzle containing a number of individual smaller cylindrical channels or tubes that are long compared to channel exit width so that much of the air flow directionality is maintained at the location of the hands being dried. In order to reduce the effect of turbulence when the forceful air stream impacts the hands, the individual channels are arranged so that there are regions of slower airflow and less turbulence between the turbulent impact regions. This provides the turbulent air the opportunities to escape the turbulent regions because of shorter distances to less turbulent areas. In addition, the evaporating water from the water film on the hands will have shorter distances for removal.

In regions where the dryer is used frequently, it is sometimes found that large amounts of debris are sucked into the dryer housing and collect outside the filter input or on a grill protecting the air inlet(s). It is therefore desirable to easily clear or reduce the debris in order to reduce the maintenance workload. By using a blowback feature our hybrid dryer achieves this.

In another version of the invention, a propeller driven by the air flowing to the exit channels will rotate and sequentially block the inputs to the individual air exit channels. This gives a pulsing aspect to the air exiting and provides alternating regions of reduced airflow. This facilitates the escape of the water being removed and also modifies the turbulent air impacting the surface

The drawbacks and deficiencies of the prior art are overcome or alleviated by the dryer of the present invention. An illustrated embodiment of the invention is a dryer, which uses optimized air outlets to generate and conserve both effective and/or optimum force and temperature at the remote location of the user's hands while conserving energy and time.

In making this invention, the physics involved guided the design and the test measurements that were used to validate the design and the expected performance. The measurements used to evaluate the various alternatives (such as number of sub-nozzles, their individual and composite areas, the spaces between sub-nozzles, their angles from normal 90° impact to the hands, etc.) were used to demonstrate the beneficial results and functioning of the invention and did not constitute undue experimentation, but were needed to demonstrate the utility of the invention.

The above-discussed and other features and advantages of the present invention will be appreciated and understood by those skilled in the art from the following detailed description and drawings.

### BRIEF DESCRIPTION OF THE DRAWINGS

FIG. 1 depicts the system, for rapid, comfortable, safer, drying of hands.

FIG. 2 depicts the array of multiple air exit sub-nozzles.

FIG. 3 shows different airflows for various exit versions.

FIG. 4. Shows sub-nozzles to provide enhanced noise reduction.

FIG. 5 provides a graph of the reduction of hand air impact noise as function of number of multiple air exit nozzles.

FIG. 6 shows various nozzle alternatives.

FIG. 7 shows different versions of compound directional nozzles.

FIG. 8 shows a dryer with a blower, heater, ion source and a compound directional nozzle with an array of sub-nozzles, plus exiting air sub-jets containing ions.

### DETAILED DESCRIPTION OF THE INVENTION

An illustrated embodiment of the invention is a dryer that provides decreased drying time and decreased air hand impact noise and also provides the user with a high degree of comfort. Comfort is a feeling of warmth, both during and after the drying process has been concluded, and a sufficient level of dryness after the drying process is completed.

In the measurements performed related to the invention, dryness was considered attained when the residual water averaged for a typical population on the hands (or other surface) is 0.20 grams or less. This is based on the subjective feelings of comfort from a number of subjects, followed by measurement of the weight of water remaining on the hands of the subjects. This small amount of residual water guarantees that evaporative cooling immediately after drying is so low as not to be noticeable by the user. Thus there is no need for the frequently observed wiping of hands on clothing after using the usual hand dryers.

The present invention includes the following features:

### Jets of Air

In the basic version of the hand dryer a single exit nozzle is used. In our version of the air exit, a compound directional nozzle is used. It contains multiple cylindrical air exit sub-nozzles used in order to provide forceful sub-jets of air with quieter regions between these jets. This is designed to reduce hand impact noise by providing shorter distances for the forceful turbulent air to expand on impact. The turbulence associated with the air impact on the hands provides undesirable noise, unless these means are provided to reduce turbulence. The escape of the evaporated water into the less turbulent regions, with shorter paths, will improve the drying rate.

### Two-Phase Drying.

In this hand dryer, the sub-jets of fast forceful air will first blow off the loose water droplets, leaving residual water as films of water on the hands. The fast forceful air will continue as phase 2 to continue to destroy the stagnation layer while evaporating the residual water on the hands. The general principles of two-phase drying have already been described in U.S. Pat. No. 7,039,301 B1, to Aisenberg, et al.

In the present invention, this low amount of surface water remaining on the hands after drying by the fast air jet(s) provides a higher level of comfort than currently accepted in the industry. In today's practice, conventional evaporative dryers remove much of the initial water on hands surfaces, but on average, after a 30 second drying cycle, about 0.40-0.50 grams of residual water remains on the hands and the hands feel cool and clammy because of the evaporation of the residual water. Frequently wiping the clammy hands on the clothing follows the drying using conventional drying and this is not desirable from a sanitary point of view. In fact it reduces the benefits of washing.

In addition to enhanced comfort due to less residual water, the present invention provides “in-process comfort” which is a feeling of warmth during and after the drying cycle. Such comfort normally correlates to a residual water amount of 0.20 grams or less for an average population. The hands felt warm and comfortable after drying.

### Reduced Energy Requirements

The design of the present hand dryer will dry the hands faster, and thus will use less electrical energy. Reduced energy use is a desirable objective in order to reduce operating cost and because of the national need to conserve energy.

### Hand Impact Noise Reduction

It has been observed that when the forceful directional flow of air impacts the hands the noise level increases. Electronic sound decibel instruments were used for the sound measurements.

Lessening of noise by use of compound directional nozzles containing sub-nozzles is explained as follows: It has been observed that when the forceful directional flow of air impacts the hands the noise level increases. In order to reduce the air impact noise on the hands, one implementation of the invention introduces regions within the total forceful airflow where the flow is reduced. This permits the impacting air to disperse and flow sideways over a shorter distance to a region having lower air force than would be possible for the total forceful airflow. Thus we use an array of directional forceful airflows, with less forceful airflows included within the array of total forceful airflows.

A version of our dryer includes a cylindrical compound directional nozzle, containing an array of cylindrical air exit sub-nozzles. The nozzle or array of sub-nozzles are such as but not limited to circular, where the length of the nozzle is longer than the largest inner width of the nozzle, by a factor such as but not limited to 3 or 5 times the largest inner dimension. By using an air exit that is much longer than the transverse dimensions, the air sub-jets from the sub-nozzles are forced to have a much larger axial flow velocity than in the perpendicular direction so that the exiting air retains its directional component when it impacts the hands. Rotating and rubbing the hands in the array of air sub-jets increase the coverage of the hands by the array of air-jets that is smaller than the hands. The result of using an array of cylindrical or tubular sub-nozzles is the reduction of the noise produced when the air sub-jets impact the hands being dried, or other surfaces.

It has been demonstrated by us that a version of our dryer with multiple cylindrical air exit sub-nozzles (that has spacing between the cylindrical nozzles) reduces the hand impact noise produced by the impact turbulence of the individual air streams (air sub-jets) on the impact locations of the fast air streams. For narrower air streams there is less of a path for the high velocity air to escape. For dryers that use fast streams of air for drying, the noise produced when the fast flowing air impacts the surface to be dried, can be high enough to disturb the user or even others in adjacent locations. In one version of our dryer, multiple, parallel tubular exit sub-nozzles are used to result in reduced noise that otherwise would be produced when fast air impacts on surfaces.

### Preferred Embodiment

A preferred version of our dryer has a compound directional nozzle containing multiple cylindrical air exit sub-nozzles with spacing between the cylindrical sub-nozzles. This reduces the measured hand impact noise produced by the turbulence of the individual air streams on the hands. For the case of spacing between the fast air streams there is a shorter path for the high velocity air at the impact location to escape to a region with less airflow, and less turbulence. For dryers that use fast streams of air for drying, the noise produced when the fast flowing air impacts the surface to be dried, can be high enough to disturb the user or even others in adjacent locations. In one version of our dryer, the compound directional nozzle consisting of multiple, parallel tubular exit sub-nozzles are used to result in reduced noise that would be produced when a fast air jet impacts on surfaces.

The multi-jet design allows for tilting jets to different angles of impact on the wet hands in order to achieve skimming or skiving off of water, which would require less energy and thus less noise than normal angular impact.

Because the hands in the jet or jets of fast air are not inserted into an enclosure as some had dryers require, the user has the opportunity to rotate the hands, and to wipe the hands and to bring out water trapped between the finger webs. Thus the drying speed is improved.

Another feature of the preferred embodiment is the inclusion of ions in the exiting air streams. As explained later, the positive ions may assist in faster evaporation of the water.

Evaluation measurements shows that for our dryer, using a compound directional nozzle containing four sub-nozzles in a 1.350″ diameter sheath, hand impact noise diminished by about 8 db to a value of about 90 db—when compared with our standard single aperture nozzle operating with the same drying speed and dryness (less than 0.20 grams of residual water) at 98 db. This is a large difference in noise level, easily perceived as much quieter by the user and beneficial to the user in terms of comfort. In both cases, total impact area was identical at 0.51 sq in.

In order to reduce the air impact noise on the hands, one implementation of the invention introduces regions within the total forceful airflow where the flow is reduced. This permits the impacting air to disperse and flow sideways over a shorter distance to a region having lower air force than would be possible for the total forceful airflow without quieter regions. The escape of evaporated water over shorter distances is another advantage. Thus we use an array of directional forceful airflows, with less forceful airflows included within the array of total forceful airflows. Sound measurements verify the expectations of reduced noise.

### Switching of Power to the Blower Motor

In order to provide the choice of faster drying with larger air hand impact noise, or alternatively slower drying with reduced air hand impact noise, the invention provides the ability to set the power applied to the blower motor during assembly with a selector switch contained within the closed enclosure to prevent unauthorized changing.

Alternatively the dryer can contain such a switch that can be operated without opening the enclosure. A switch accessible by a key from the outside of the enclosure can be provided so that an authorized person can select between the noisy, fast choice or the quieter slower drying. Another option is to provide labeled buttons or switch on the outside of the enclosure so that users can select the type of drying they prefer.

### Addition of Ions to Air Flow

The use of ions for improving the drying of hair has been described in U.S. Pat. No. 6,640,049 B1 to Lee, which is included here for reference.

Also the use of ions for improving the drying of hair has been described in U.S. Pat. No. 7,047,660 B2 to Leventhal, which is included here for reference. Many of the current hair dryers involve the inclusion of ions in the blowing air, and are produced by Tourmaline. The mineral Tourmaline crystals are pyroelectric and when warmed become positively charged at one end and negatively charged at the other end. This method of producing ions is simpler than the use of high voltages to produce electrical corona and ions.

In our present invention we may combine the ion producing properties of heated Tourmaline and the forceful air jets produced by our compound directional nozzle to give faster removal of water on surfaces, such as washed hands.

Actually, we prefer to use a corona discharge in the dryer to add charges such as ions and/or electrons to the air exiting as described for hair drying by Ramchandani in U.S. Pat. No. 6,191,930.

A corona discharge is a collection of ions and electrons in low-density plasma formed the tip or tips of sharp electrical conductors. A high voltage power supply provides the strong electrical field at the sharp tips. The electric field gradient (volts/cm) at the tip is inversely proportional to the radius of curvature of the end of the tip—and for a large enough gradient there is electrical breakdown producing a corona. The voltage supply is current limited to prevent a high current arc from forming. This corona supplies ions and electrons to the exiting air.

The reason and basic physics for the increase in evaporation rate due to electrical charges on the drops (and film) can be explained as follows:

The electrical energy stored by a charge of Q coulombs (negative or positive) on a surface is equal to Q×Q/C where C is the electrical capacitance of the surface. A molecule of water evaporating from the surface reduces the energy (and is thus limited) by the heat of evaporation. At the same time the area of the drop surface is reduced thus reducing the electrical capacitance and increasing the electrical energy stored. The charge Q remains the same during the evaporation event. The gain of electrical energy compensates for some of the energy lost by the heat of evaporation, so that the evaporation can occur more readily and faster.

Thus, the increase of electrical energy stored on the capacitance of a drop increases as the area of the drop decreases with the evaporation of a water molecule. This partially compensates for the energy lost by the evaporation of the molecule. Thus the drying is accelerated by the addition of ions. The ions and electrons are introduced into the air stream from a corona discharge.

With the above and other such objects in view as may hereafter more fully appear, the invention consists of the novel constructions of apparatus illustrated in the drawings and described in the specifications as well as the methods set forth hereafter, but it is to be understood that changes, variations, and modifications may be resorted to which fall within the scope of the invention as claimed without departing from the nature and spirit of the invention.

### DETAILED DESCRIPTION OF THE DRAWINGS

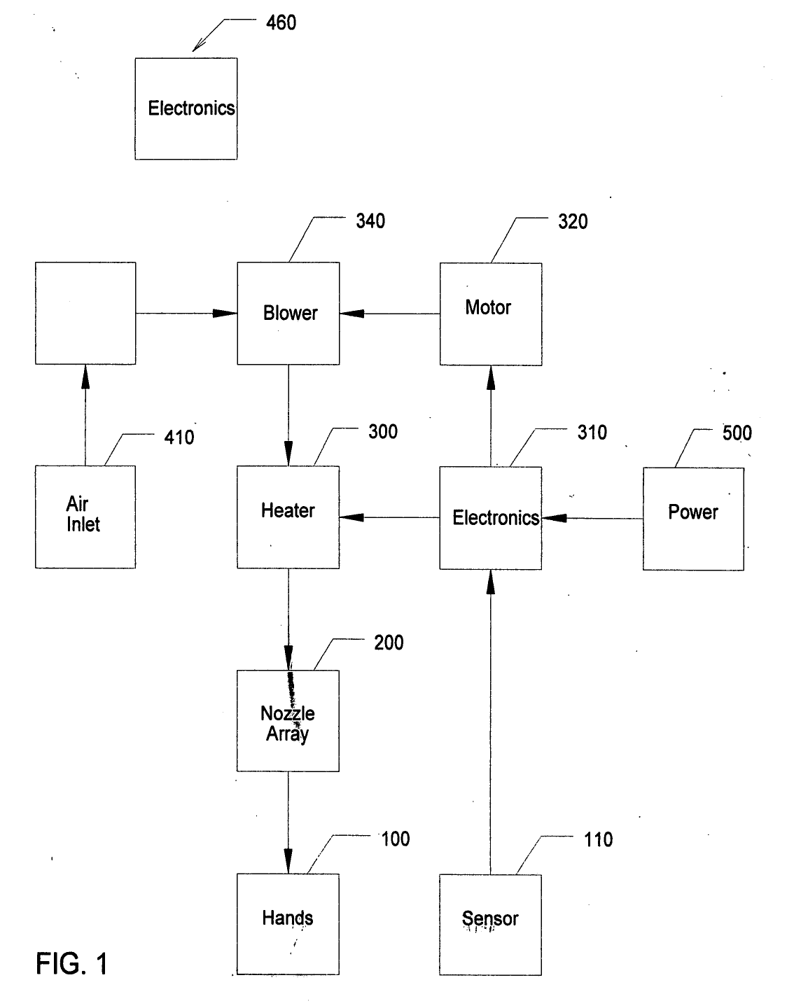

FIG. 1 depicts the system, for rapid, comfortable, safer, drying of hands 100, using less energy and time, It is a diagrammatic view of a hand dryer in an illustrated embodiment of the invention. The hand dryer includes a number of major components including a blower 340, an air heater 300 and air outlet nozzle or nozzle array or compound directional nozzle 200. Additional components, such as a control electronic device 310 for initiating the drying cycle, timing the drying cycle, and stopping the dryer, may be included as known in the art. A sensor or switch 110 for starting the drying cycle can be a pressure switch, an optical proximity sensor, or a capacitance sensor. The blower 340 may be a fan-type blower, vacuum cleaner blower or a multistage blower for larger output pressure which directs air through the following heater 300 and out through air exit nozzles 200. The motor 320 is an electric motor. The heater 300 may be any known type of heater including a wire wound heater that generates heat through resistive elements and/or an infra-red heater. The blower 340 and the air outlet nozzles 200 are selected so as to provide effective drying as described herein. As described in further detail herein, the volume output of blower 340 and the size and shape of air outlet nozzles 200 are selected so as to provide both blow-off drying and evaporation drying with reduced air hand impact noise.

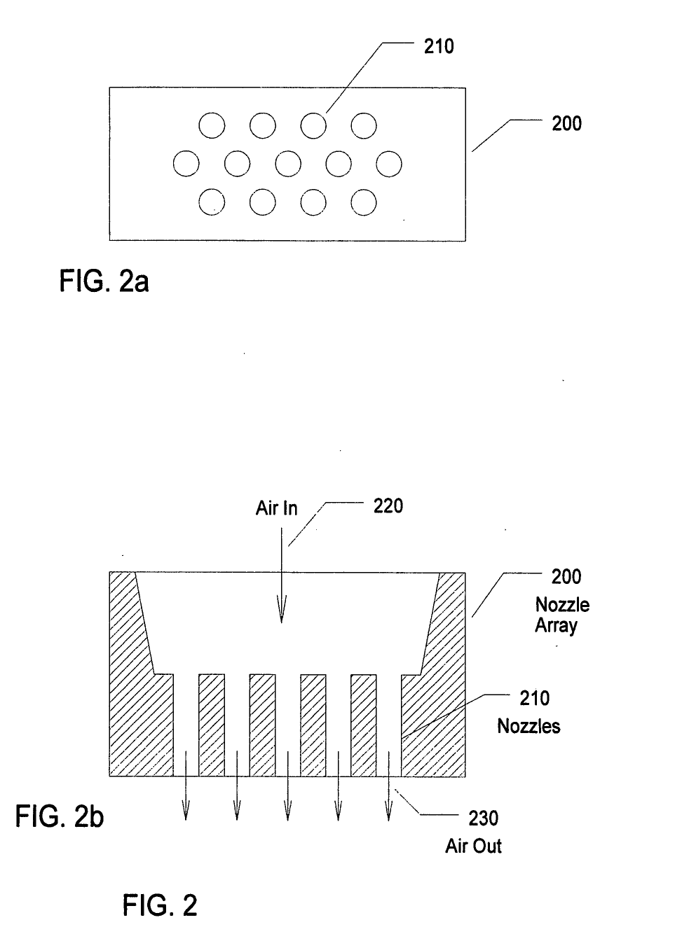

FIG. 2 depicts the array of multiple air exit sub-nozzles showing an array base 200, and a bottom view

FIG. 2a shows the multiple nozzle openings or tubes 210.

FIG. 2b is a side view that shows the air 220 entering the array 200 and the nozzles 210, and the jet of directed air 230 exiting towards the hands. In the present invention, much of the axial direction and force and temperature of the exiting air was preserved by the use of cylindrical (circular or other shapes) tubular air exits. By making the cylindrical length large compared to the lateral dimensions of the tube, the air components with velocity component transverse to the flow axis are directed back to the axis where they can gain axial flow velocity features and reduce transverse velocity components. The cylindrical length should be larger than the transverse dimensions, and values such as but not limited to greater than 3 to 7 can be used.

In order to obtain high force and high temperature in the air stream exiting the air outlet, entrainment of the air stream is managed. Entrainment is the phenomenon of outside air being drawn into the air stream through a Venturi effect. As the speed of an airstreams increases, entrainment increases. Entrained air increases blow-off performance because the entrained air increases the mass and momentum force of the air stream and thus provides more force to the drying surface. For a given air stream speed, the air entrainment further increases with decreasing air outlet opening diameter. This is because relatively more of the air stream is in contact with the outside air because the ratio of perimeter (where entrainment occurs) to cross sectional area increases.

It was determined that for outlets of circular cross section, rapid drying occurs for the circular outlets having diameters of 0.57″, 0.76″ and 0.815″. For these outlet circle diameters, the ratios of perimeter to area are 6.9, 5.3, and 4.9 respectively, in units of reciprocal inches. These values are calculated as shown in the following formula relating the perimeter P of the circular tubular air outlet, and the radius r of the outlet.

For circular air exits

P/A=(2*Pi*r)/(Pi*r*r)

or

P/A=2/r

Diameter D=2*r

So P/A=4/D in reciprocal inches.

Note that Pi=3.14159 and cancels out in the equations.

The P/A ratio will have an effect on the drying time.

The inside diameter of the cylindrical circular nozzle in this invention is such as but not limited to 5/16 inches. Using the formula for P/A=2/r the value of P/A is 12.9.

For the case of multiple sub-nozzles, where the nozzles are close together, the air entrainment is reduced by the proximity of the nozzles.

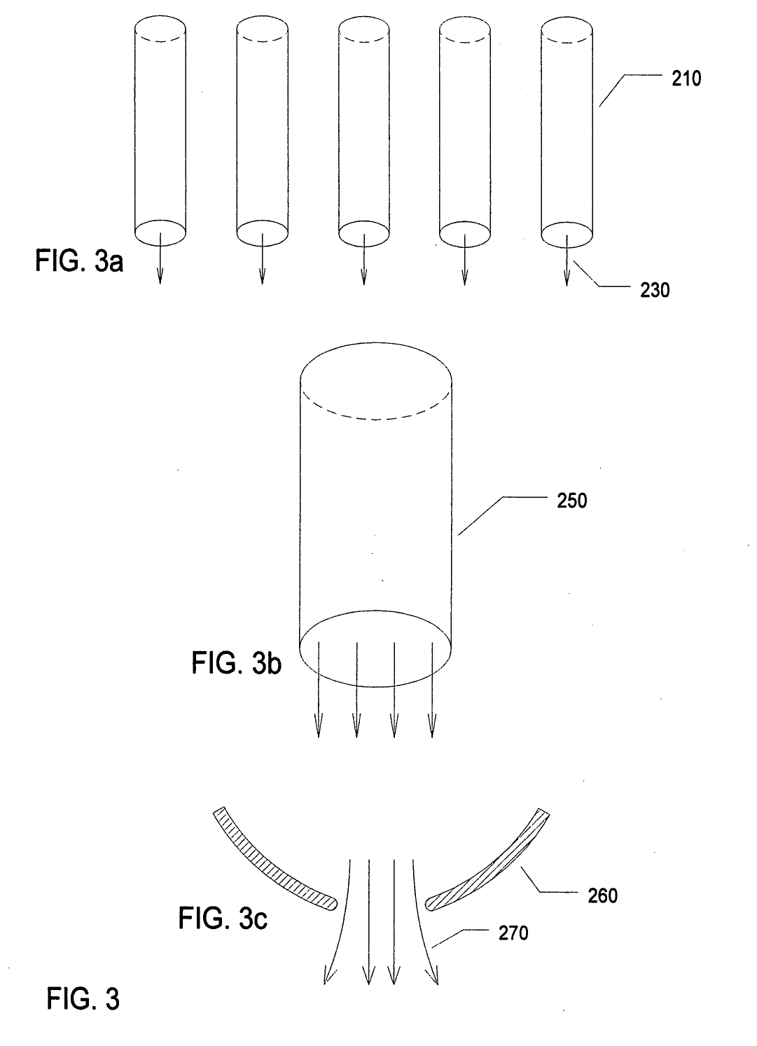

FIG. 3 shows different airflows for various exit versions

FIG. 3a different airflows for various exit versions used in the present invention showing the array of multiple tubular air exits 210 and the exiting air 230 providing reduction of air hand impact noise.

FIG. 3b shows the case of a larger diameter individual tubular air exit 250 where the P/A is smaller and the air entrainment is larger.

FIG. 3c shows the usual simple opening 260 in other hand dryers where the air exits and diffuses quickly.

Rapid drying occurs in circular outlets having a P/A ratio ranging from about 5 to 7. Conventional evaporative dryers with non-circular outlets as wide as 4″ typically have P/A ratios as low as 1.0. When the air entrainment is very large, the average temperature of the warm exiting air decreases rapidly, when mixed with large quantities of room air, which results in reduced evaporation rate.

While entrainment of cool room air can increase air stream force, it also reduces the air stream temperature. Accordingly, to perform more effective evaporation and to provide the user with in-process comfort (i.e., warm hands during and immediately after drying) it is important not to entrain too much air. Entraining air causes a reduction of temperature of the heated air that is used for the later stages of hand drying which involves evaporation of water films that cannot be readily blown off.

Circular air outlets provide an advantage over other outlet shapes because they give the lowest P/A ratios for the largest enclosed areas because the perimeter of a circle encloses the greatest area of any geometrical figure. Air outlet shapes of other forms such as ellipses, slots, etc., will also provide satisfactory results, but, depending on the degree of deviation from the circular, may exceed the desired range of P/A ratios—under which condition they will work poorly. This is also the case for multiple airstreams from the same blower source.

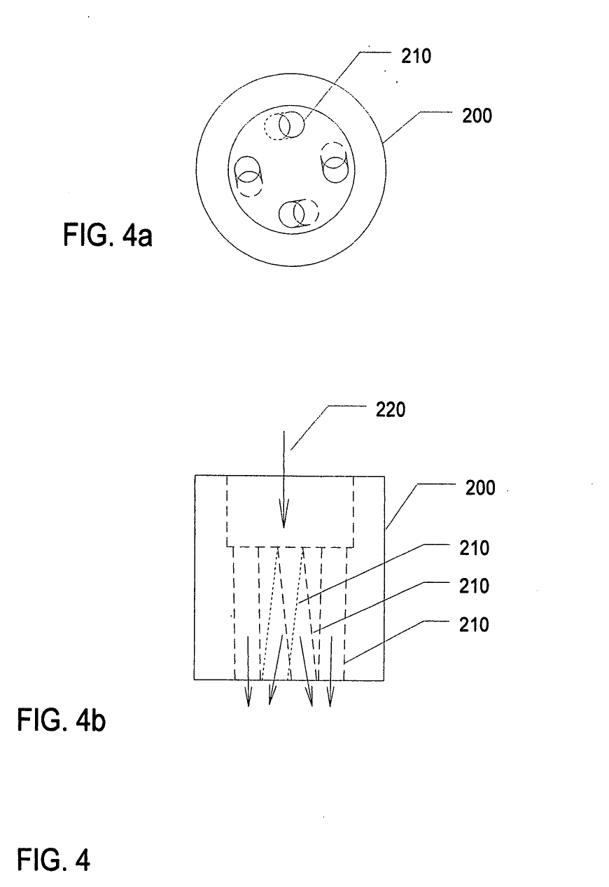

FIG. 4. Shows tilted nozzles to provide enhanced noise reduction.

FIG. 4a is a top view, and

FIG. 4b is a side view. They show the array of multiple tubular air exits (sub-nozzles) 210 and the exiting air 230 providing reduction of air hand impact noise. Note that in this version, the multiple tubular air exit nozzles are tilted at an angle with respect to the base 200 supporting the multiple tubular air exits.

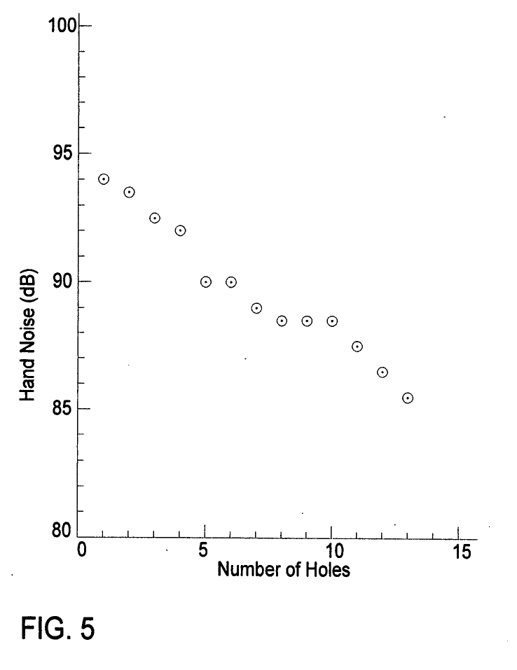

FIG. 5 provides a graph of the reduction of hand air impact noise as function of number of multiple air exit nozzles.

The following table presents the data for the dependence of hand impact noise on the number of opened holes for a nozzle with thirteen sub-nozzles

| | Hand Impact Noise in db |
|---|---|
| Number of open holes | (average of 4 readings) |
| 1 | 94 |
| 2 | 93.5 |
| 3 | 93 |
| 4 | 92 |
| 5 | 90 |
| 6. | 90 |
| 7 | 89 |
| 8 | 88.3 |
| 9 | 88.3 |
| 10 | 88.3 |
| 11 | 87.5 |
| 12 | 86.5 |
| 13 | 85.5 |

It can be seen that the measured hand impact noise on the hands is reduced from 94 db for one sub-nozzle to about 84.5 when all 13 sub-nozzles are opened.

One goal is to reduce the air impact noise on the hands during drying to about 85 db or less while still achieving good drying (such as but not limited to less than 15 seconds, with less than 0.20 gm of residual water remaining on the hands corresponding to hand comfort for an average for typical test population).

Verification of the theory of noise reduction was demonstrated by a number of measurements using an electronic sound db meter to quantify the effect of multiple nozzle holes on noise during drying. The corrected A-scale in the db meter was used for db data. The expectation was that as the number of holes was increased, the air exit velocity would decrease, with a corresponding reduction of air impact turbulence and hand impact noise. This was found to be the case and the hand impact noise decreased as the number of unplugged holes was increased.

The use of individual exit tubes (sub-nozzles) was expected to produce gaps in the distribution of air impact turbulence on the hands with the increased ability for the turbulent air to escape because the paths were shorter than for a larger diameter turbulent air stream.

The hand impact noise was reduced because there were regions of relatively quiet air between the multiple strong air jets where turbulence was high. The individual turbulent air jets were able to escape more easily than for an air jet of larger diameter.

The ability to use up to 13 holes was chosen. Also, with the expanded area covered by the multiple, separated sub-nozzles we expect more effective drying.

Drying effectiveness in 15 seconds was now evaluated for the 13-hole nozzle using actual hands. The average weight of residual water for 4 tests was 0.14 gm. This makes the 13-hole nozzle as effective in drying time as a 1.1″ diameter single exit nozzle, but with about 85 db of noise vs. 91 db for the 1.1″ nozzle.

While the structure of a 13 tubular multi hole nozzle is complex, we feel that a skilled plastics firm could fabricate it readily, possibly with extrusion technique. On the other hand, a lesser number of sub-nozzles, even as few as three or four, still provide substantial benefits. Tradeoffs of number of sub-nozzles in reducing drying noise and increasing drying speed can be considered for optimizing production costs.

A preferred air exit nozzle array would consist of four cylindrical sub-nozzles arranged within a circle about such as but not limited to 1 to 1.5 inches diameter with spaces between the sub-nozzles and air jets to reduce the hand impact turbulence noise. Each sub-nozzle if this embodiment would have an area of 0.1282 in² and a combined area for all 4 of 0.5128 in². A single nozzle with the same area but without the included sub-nozzles produced significantly higher hand impact noise (98 db) than in this four sub-nozzle case (90 db).

Better use of the blower output is obtained when the total area of the exit nozzle or nozzle array is such that the air pressure to the nozzle array is about one half of the blank off output pressure of the blower. This also corresponds to the case where the air exiting the nozzles is about one half of the blower output without any nozzle restriction to the flow. There are obviously regions of nozzle area where the use of the blower is more effective. When the blower airflow is high relative to its intrinsic capability the airflow pressure is low. When the blower airflow is low because the air exit area is low the exiting air force is high but the volume of exiting air is low. The optimum operating conditions correspond to the case where the product of the airflow volume and the exiting air force is close to a maximum. This is similar to the well-known case in electronics where maximum power to a load resistance is obtained from a battery with internal resistance when the load resistance is equal to the internal battery resistance.

It should be pointed out that the choice of 5/16″ diameter sub-nozzle holes was arbitrary. The concept of the invention can be extended to other size cylindrical openings or cylindrical holes.

The P/A ratio for these 5/16″ diameter holes is 4/D=4*16/5=12.8 and is responsible for strongly directed air at the location of the hands because of the reduced air entrainment.

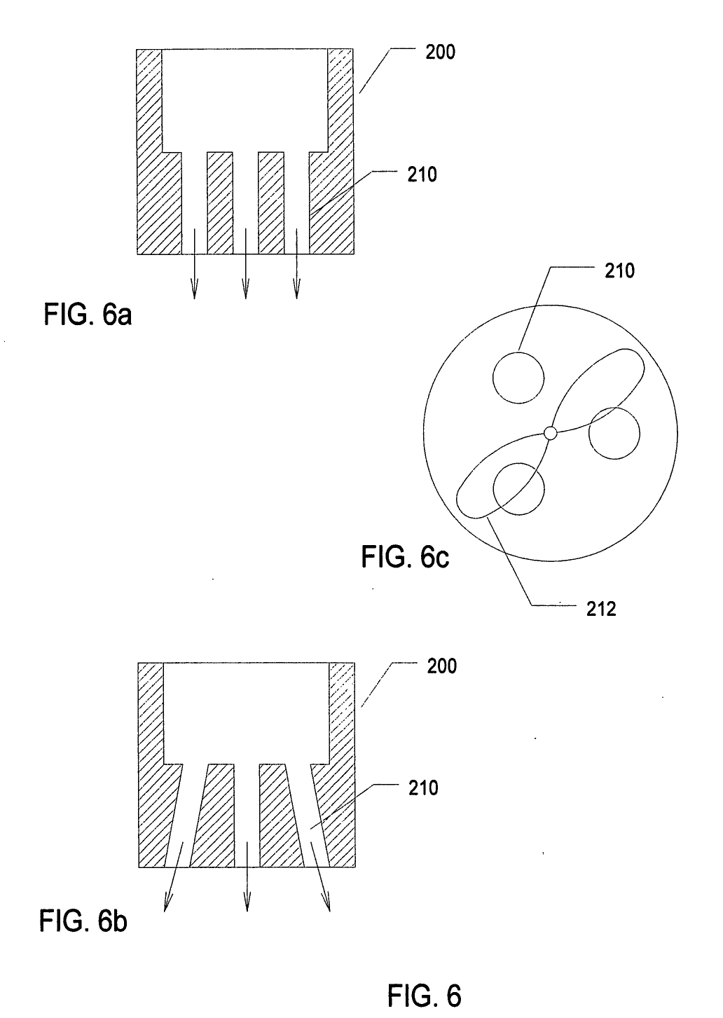

FIG. 6 shows various nozzle alternatives.

FIG. 6a shows a nozzle structure 200 with air exit channels 210.

FIG. 6b shows the channels 210 diverging so as to cover a larger area of impact and to dry larger areas at a time.

FIG. 6c shows a propeller 212 that can be included to alternately cover air exit channels 210 to provide pulsing air jets to facilitate the escape of water.

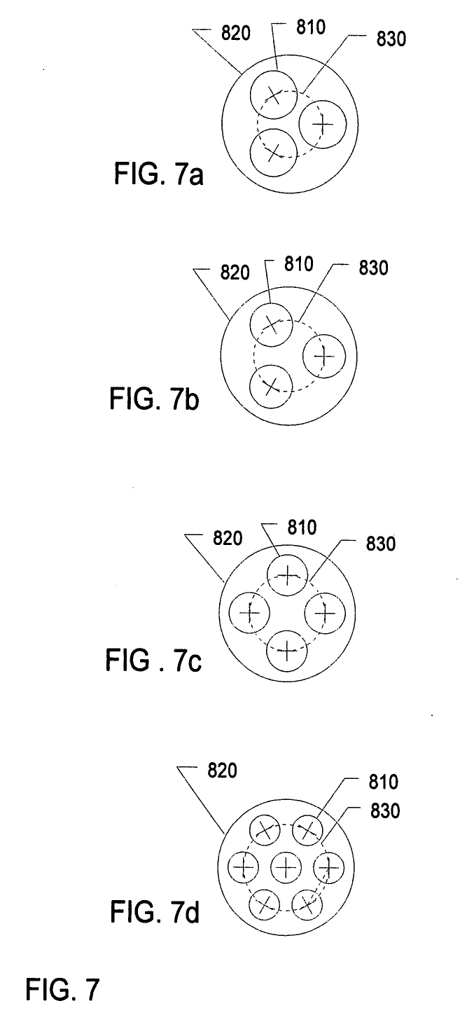

FIG. 7 shows different versions of compound directional nozzles.

FIG. 7a shows a compound directional nozzle 820 with 3 sub-nozzles 810 with separations 830 between sub-nozzles 810 to provide separate jets of hot air.

FIG. 7b shows a compound directional nozzle 820 with 3 sub-nozzles 810 with larger separations 830 between sub-nozzles 810 to provide separate jets of hot air, with larger separations to facilitate escape of turbulence and water.

FIG. 7c shows a compound directional nozzle 820 with 4 sub-nozzles 810 with separations 830 between sub-nozzles 810 to provide separate jets of hot air.

FIG. 7d shows a compound directional nozzle 820 with 7 sub-nozzles 810 with separations 830 between sub-nozzles 810 to provide separate jets of hot air.

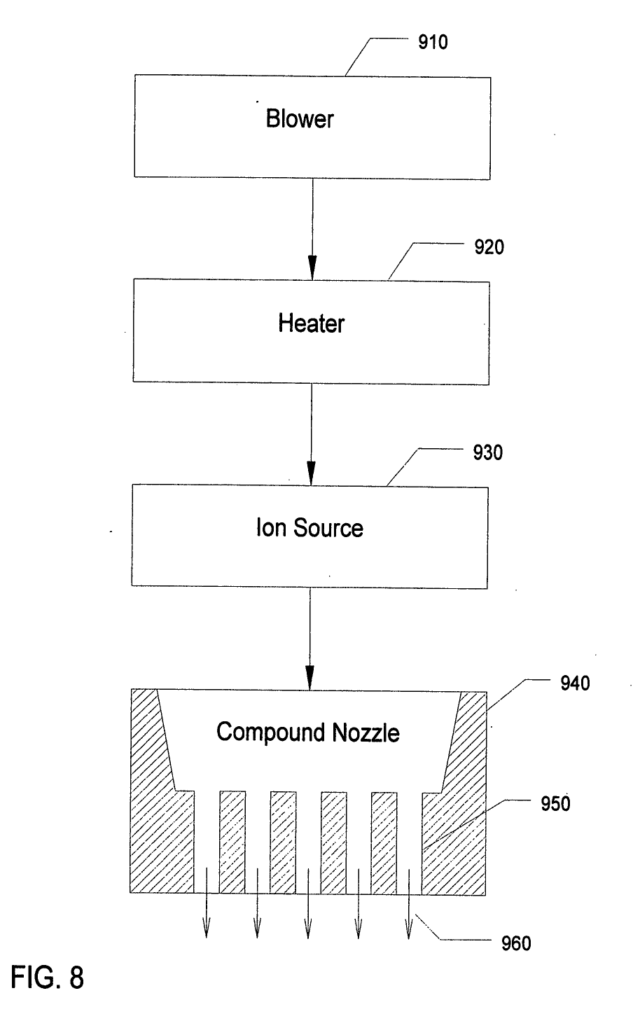

FIG. 8 shows a dryer with a blower 910, followed by a heater 920, followed by an ion source 930, feeding a compound directional nozzle 940 containing an array of sub-nozzles 950, and exiting air sub-jets 960 containing ions.

The foregoing description has been limited to specific embodiments of the invention. It will be apparent, however, that various variations and modifications may be made to the invention, with the attainment of some or all of the advantages of the invention. It is the objective of the appended claims to cover these and such other variations and modifications as come within the true spirit and scope of the invention.

We claim:

1. A method of operating a hand dryer comprising the steps of:
(a) generating air jets from a compound directional nozzle with multiple cylindrical sub-nozzles,
(b) heating the air sub-jets exiting the sub-nozzles to a temperature such that, upon contact of air from the air jets with hands of a user, the temperature of the air jets will be about 135° F.,
(c) directing heated air jets through multiple cylindrical nozzles onto the hands of the user in a blow-off phase at a velocity no less than 18,000 linear feet per minute and sufficient to blow off at least 75% of water adherent to the hands of the user in at most 3 seconds and to break up a stagnation boundary layer of water on the user's hands,
(d) continuing to direct heated air through the nozzle air jets onto the hands of the user to dry the user's hands to a residual water quantity of at most 0.3 grams in less than 15 seconds in an evaporation phase subsequent to the blow-off phase.

2. The method of claim 1 wherein the total cross sectional areas of the mouths of the multiple sub-nozzles will occupy no more than three quarters of the total cross sectional area of the sheath in the interior of which the sub-nozzle structures are deployed.

3. The method of claim 1 wherein the total cross sectional areas of the openings of the multiple sub-nozzles will be within in a range defined by an approximate minimum in a curve plotting drying effectiveness vs. total cross sectional area. That minimum defines the desired least retained water on the hands after drying and is the chosen operating point to which to adjust nozzle area for any dryer design, where an Optimum Air Impact Area, (OAIA) has nozzle areas between 0.3 in² and 0.6 in² areas for a good combination of low noise and rapid drying.

4. The method claim 1 wherein the heated air is directed onto the user's hands from a compound directional nozzle at a lesser velocity than the velocity in step (c) yet sufficient to dry the user's hands to a residual water quantity of at most 0.3 grams in less than 15 seconds in an evaporation phase subsequent to the blow-off phase.

5. A method of drying a wet surface comprising the steps of:
(a) generating a forced flow of air with an electrically powered blower,
(b) heating the forced flow of air with an electrically powered heater to produce a heated air stream,
(c) directing the heated air stream from the sub-nozzles of the compound directional nozzle onto the surface with some or all of the sub-nozzle having a length of 3 to 5 times the largest linear dimension across the cross section of the sub-nozzle to blow off the surface at least 75% of water adherent thereto in a period less than 5 seconds.

6. The method of claim 5 wherein the heated air stream is trained on the surface through nozzles or sub-nozzles with some or all having a ratio P/A of perimeter P to cross sectional area A of 2.5 to 7 reciprocal inches.

7. The method of claim 5 wherein on the surface formed by wet hands of a user, the heated air streams from the sub-nozzles of the compound directional nozzle are directed against the hands of the user with enough power to reduce an air stagnation region adjacent to a film of water on the hands of the user and accelerate evaporative drying thereof.

8. The method of claim 5 wherein the surface is formed by wet hands of a user and the heated air streams from the sub-nozzles are directed against the hands of the user so as reduce residual water on the hands to an average of 0.2 grams or less for an average population of hand sizes in less than 15 seconds.

9. The method of claim 5 wherein the surface is formed by wet hands of a user and the heated air stream from the sub-nozzles are directed against the hands of the user at an angle tilted from the normal with the hands to any of a range of angles from 20 degrees to 60 degrees so as to add a skimming or skiving action to reduce residual water on the hands to an average of 0.2 grams or less for an average population of hand sizes in less than 15 seconds and to do so with a reduction of air stream impact noise.

10. The use of a compound directional nozzle with smaller diameters as a way for reducing empty space to obstruct users from stuffing a nozzle with foreign material while still not impeding the total air passage process such as that used in hand drying.

11. The method of claim 5 wherein the blower is provided with multiple air outlets dimensioned such that a product of airflow volume and exiting air pressure is at or near a maximum.

12. The method of claim 5 for drying hands of a user comprising the steps of:
(a) generating a forced flow of air with an electrically powered blower where the air enters through a filter,
(b) heating the forced flow of air with an electrically powered heater to produce a heated air stream,
(c) directing the heated air stream onto the hands of the user through a nozzle comprising at least two cylindrical air exit sub-nozzles to reduce residual water on the hands to an average of 0.2 grams or less for an average population of hand sizes in less than 15 seconds.

13. The method of claim 5 wherein the blower is operated at a power sufficient at least initially, as in less than five seconds, to blow off at least 75% of the water originally adhering to the hands of the user and then to evaporatively dry the hands of the user.

14. The method of claim 5 wherein the heated air stream is directed against the hands of the user from at least two of the sub-nozzles.

15. A method using a compound directional nozzle to produce forceful sub-jets of air with impact area separations to permit turbulence and water to escape from the impact surface.

16. The method of claim 5 wherein hand impact noise is at least 5 db less impact noise than would have been when generated by the same drying application when a compound directional nozzle is not used, and where the alternative non-compound directional nozzle consists of a sheath of the same dimensions as for the compound directional nozzle, but having no interior sub-nozzles.

17. A method adding ions to the compound directional nozzle and air sub-jets so that electrical charges on the drops and the reduced electrical capacitance of the drop will compensate (or partially compensate) for the energy lost by the heat of evaporation—to speed up the drying.

18. A method for selecting the power applied to the blower motor during device assembly or switching manually before each drying event or sequence of such events so as to give the choice of normal power that provides fast hand drying with the drawback of increased hand impact noise from the fast air during drying, or alternatively the choice of lower blower power to reduce the hand impact noise with a penalty of slower drying.

19. An apparatus for rapidly and comfortably drying hands comprising:
(a) a blower for generating air jets,
(b) a heater for heating the air jets to a temperature of about 135 deg F.,
(c) an air exit using compound directional nozzle having multiple cylindrical air exit sub-nozzles directing air sub-jets on the hands of the user to blow off loose water in less than 5 seconds and to evaporate surface water from the hands in at most 15 seconds, leaving less than 0.2 gm of water on the hands, whereby the hands feel warm and comfortable.

20. An apparatus for rapidly and comfortably drying hands comprising:
(a) a blower for generating air jets,
(b) a heater for heating the air jets to a temperature of about 135 deg F.,
(c) a compound directional nozzle with multiple cylindrical air exit nozzles that are divergent to cover larger impact area,
(d) a source of ions such as the mineral tourmaline or an electronic electrical circuit to produce a corona to supply ions in the exiting air.

21. An apparatus for rapidly and comfortably drying hands comprising:
(a) a blower for generating air jets,
(b) a heater for heating the air jets to a temperature of about 135 deg F.,
(c) a nozzle with multiple cylindrical air exit nozzles that are divergent,
(d) a propeller driven by the exiting air to sequentially block the entrances of the multiple cylindrical air exit sub-nozzles,
(e) a source of ions such as the mineral tourmaline or an electronic electrical circuit to produce a corona to supply ions in the exiting air.

22. An apparatus for rapidly and comfortably drying hands comprising:
(a) a blower for generating air jets,
(b) a heater for heating the air jets to a temperature of about 135 deg F.,
(c) a nozzle with multiple cylindrical air exit nozzles,
(d) a hand operated manual switch, utilized during periodic authorized maintenance, which reverses the blower motor to blow back accumulated debris through the entrance ports of the dryer.
